(19) United States
(12) Patent Application Publication
(10) Pub. No.: US 2026/0106799 A1
(43) Pub. Date: Apr. 16, 2026

(54) MANAGING SERVICE-LEVEL ENERGY EFFICIENCY IN A COMMUNICATION NETWORK

(71) Applicant: Telefonaktiebolaget LM Ericsson (publ), Stockholm (SE)

(72) Inventors: Xuejun CAI, Täby (SE); Zhang FU, Stockholm (SE); Arif AHMED, Kista (SE); Selome KOSTENTINOS TESFATSION, Upplands Väsby (SE)

(73) Assignee: Telefonaktiebolaget LM Ericsson (publ), Stockholm (SE)

(21) Appl. No.: 19/117,092

(22) PCT Filed: Oct. 20, 2023
(86) PCT No.: PCT/IB2023/060626

§ 371 Date: Mar. 31, 2025

Related U.S. Application Data
(60) Provisional application No. 63/418,781, filed on Oct. 24, 2022.

(51) Int. Cl. H04L 41/0894; H04L 41/0806

(52) U.S. Cl. CPC H04L 41/0894; H04L 41/0806

(57) ABSTRACT

Embodiments include methods for a service-level energy efficiency (EE) control function (SEECF) of a communication network. Such methods include receiving an EE management request related to a service provided to end users via the communication network and obtaining, from a data analytics function (DAF) of the communication network, EE information related to the service's operation in the communication network. Such methods include determining an EE policy for the service based on the EE management request and on the obtained EE information. Such methods include configuring one or more of the following in the communication network to operate according to the determined EE policy: one or more network nodes or functions (NNFs) that carry or facilitate data traffic for the service, one or more management functions, (MFs) that control or manage the NNFs. Other embodiments include complementary methods for DAFs, EADRs, and NNFs, and network equipment configured to implement such methods.

### TECHNICAL FIELD

The present application relates generally to the field of communication networks, and more specifically to techniques for monitoring, controlling, and/or managing operation of a communication network based on energy efficiency requirements of individual services that communicate with end users via the communication network.

### INTRODUCTION

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. 5G/NR was initially specified as part of 3GPP Release 15 (Rel-15) and continues to evolve through subsequent releases.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132 in FIG. 1).

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. Furthermore, the services are composed of various “service operations,” which are more granular divisions of the overall service functionality.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific capabilities and characteristics, e.g., in support of a particular service. A “network slice instance” is a set of NF instances and required network resources (e.g., compute, storage, communication) that provide the capabilities and characteristics of the network slice. Any NF can obtain analytics from an NWDAF using a Data Collection Coordination Function (DCCF) and associated Ndccf services. The NWDAF can also store and retrieve analytics information from an Analytics Data Repository Function (ADRF).

A similar function called Management Data Analytics Function (MDAF) is defined in the operations/administration/maintenance (OAM) domain for a 5G network. Like NWDAF, MDAF can process and analyze network- and service-related data and provide results to other entities. More specifically, MDAF focuses on management-related data and defines some services (e.g., network coverage, network slice traffic prediction, fault prediction, energy saving analysis, etc.) that can be consumed by other entities associated with a 5G network.

Many regions and countries have published related policies and requirements to control carbon release and promote energy efficiency. These policies have made energy efficiency a strategic priority for many mobile network operators (MNOs) around the world. 3GPP TS 21.866 (v15.0.0) identifies and studies key issues and potential solutions in defining energy efficiency Key Performance Indicators (KPIs) and energy efficiency optimization operations in existing and future 3GPP networks. Additionally, 3GPP TS 22.882 (v0.1.0) describes a technical study on energy efficiency as service criteria, with a goal of allowing users (e.g., end users and/or application services) to select energy efficiency criteria along with other network performance parameters for their services. Another goal is to expose systematic energy consumption or energy efficiency of the network to vertical customers.

### SUMMARY

However, existing 3GPP energy efficiency activities such as those described above are focused almost exclusively on network components, functions, and elements, with very little emphasis on managing or controlling energy consumption and/or efficiency on a service or application level. Furthermore, although MDAF provides some analytics related to energy efficiency of network elements neither MDAF nor NWDAF support analytics related to service level energy efficiency. Thus, there is an unmet need for energy efficiency management at the service level within communication networks (e.g., 5G).

Embodiments of the present disclosure address these and other problems, issues, and/or difficulties, thereby facilitating the monitoring and/or optimization of network energy efficiency at a service level rather than at a component level, as done conventionally.

Some embodiments of the present disclosure include methods (e.g., procedures) for a service-level energy efficiency (EE) control function (SEECF) of a communication network (e.g., 5GC).

These exemplary methods include receiving an EE management request related to a service provided to end users via the communication network. These exemplary methods also include obtaining, from a data analytics function (DAF) of the communication network, EE information related to the service's operation in the communication network. These exemplary methods also include determining an EE policy for the service based on the EE management request and on the obtained EE information. These exemplary methods also include configuring one or more of the following in the communication network to operate according to the determined EE policy: one or more network nodes or functions (NNFs) that carry or facilitate data traffic for the service, and one or more management functions (MFs) that control or manage the NNFs.

Other embodiments include exemplary methods (e.g., procedures) for a data analytics function (DAF) configured to provide EE analytics in a communication network (e.g., 5GC). These exemplary methods are generally complementary to the exemplary methods for an SEECF, summarized above.

These exemplary methods include receiving, from an SEECF of the communication network, a request for EE information related to operation of a service in the communication network. These exemplary methods also include determining the EE information requested by the SEECF and sending the determined EE information to the SEECF in response to the request.

Other embodiments include methods (e.g., procedures) for an energy analytics data repository (EADR) of a communication network (e.g., 5GC). These exemplary methods are generally complementary to the exemplary methods for an SEECF and a DAF, summarized above.

These exemplary methods include receiving, from a DAF of the communication network, a query for EE information related to operation of a service in the communication network. These exemplary methods also include retrieving stored EE information in accordance with the query and sending the retrieved EE information to the DAF in response to the query.

Other embodiments include methods (e.g., procedures) for an NNF configured for service-level EE management in a communication network (e.g., 5GC). These exemplary methods are generally complementary to the exemplary methods for an SEECF, a DAF, and an EADR, summarizes above.

These exemplary methods include can sending, to a first NNF of the communication network, measured EE information for the NNF during one or more time periods. The measured EE information is associated with data traffic of a service provided to end users by an application function (AF). These exemplary methods also include receiving, from an SEECF of the communication network, an EE policy that is based on the measured EE information and on an EE level requested by the AF. These exemplary methods also include operating according to the received EE policy to carry or facilitate data traffic for the service.

Other embodiments include SEECFs, DAFs, EADRs, and NNFs (or network and/or computing equipment hosting such NFs) that are configured to perform operations corresponding to any of the exemplary methods described herein. Other embodiments also include non-transitory, computer-readable media storing computer-executable instructions that, when executed by processing circuitry, configure such SEECFs, DAFs, EADRs, and NNFs (or hosting network and/or computing equipment) to perform operations corresponding to any of the exemplary methods described herein.

These and other disclosed embodiments can facilitate service level energy efficiency management and control in communication networks, which enables mobile network operators (MNOs) to meet their strategic priorities for network energy efficiency. Moreover, embodiments can be implemented based on existing 3GPP network architecture, which facilitates faster deployment and reduces deployment cost and/or complexity. Furthermore, embodiments facilitate energy-efficient delivery of services via communication networks, which increases the value of such services to end users and service providers.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a flow diagram of a procedure that illustrates various embodiments of the present disclosure at a high level.

FIGS. 4-5 show system-level block diagrams for two exemplary implementations of embodiments of the present disclosure in a communication network.

FIG. 6 (which includes FIGS. 6A-B) shows a signaling diagram of a procedure for managing EE policies in a communication network based on service-level EE requirements, according to various embodiments of the present disclosure.

FIG. 7 shows an exemplary method (e.g., procedure) for a service-level EE control function (SEECF) of a communication network, according to various embodiments of the present disclosure.

FIG. 8 shows an exemplary method (e.g., procedure) for a data analytics function (DAF) of a communication network, according to various embodiments of the present disclosure.

FIG. 9 shows an exemplary method (e.g., procedure) for an energy analytics data repository (EADR) of a communication network, according to various embodiments of the present disclosure.

FIG. 10 shows an exemplary method (e.g., procedure) for a network node or function (NNF) of a communication network, according to various embodiments of the present disclosure.

FIG. 11 shows an exemplary method (e.g., procedure) for an application function (AF) associated with a communication network, according to various embodiments of the present disclosure.

FIG. 12 shows a communication system according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, according to various embodiments of the present disclosure.

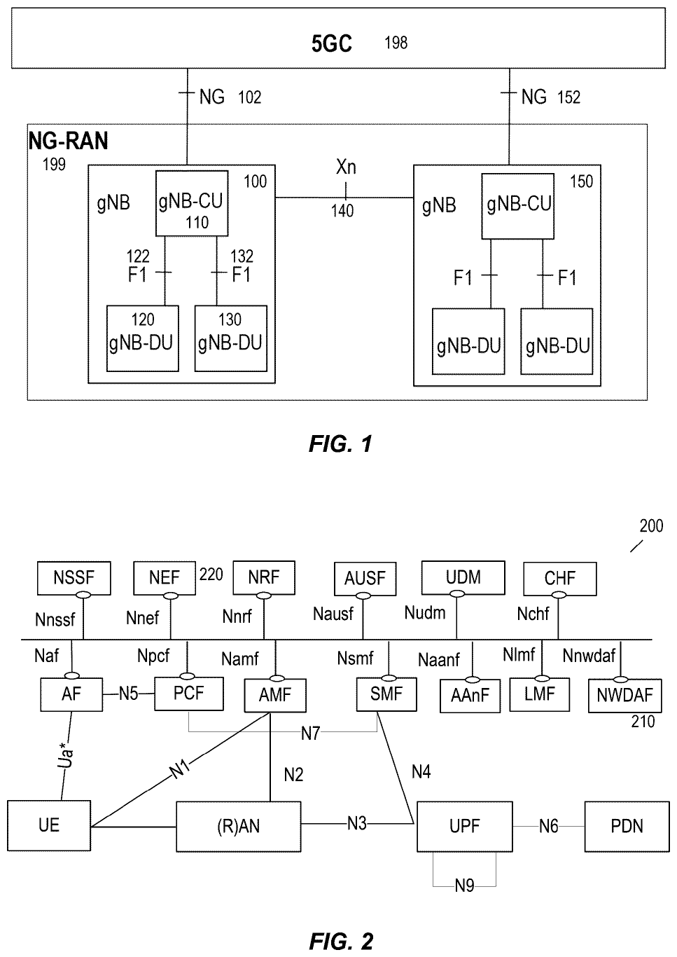

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5GC (200), with service-based interfaces and various 3GPP-defined NFs within the Control Plane (CP). These include the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)— supports handling of user plane traffic based on the rules received from SMF, including packet inspection and different enforcement actions (e.g., event detection and reporting). UPFs communicate with the RAN (e.g., NG-RAN) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF, 220) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 210) with Nnwdaf interface, described in more detail above and below.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

3GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

Machine learning (ML) is a type of artificial intelligence (AI) that focuses on the use of data and algorithms to imitate the way that humans learn, gradually improving accuracy as more data becomes available. ML algorithms build models based on sample (or “training”) data, with the models being used subsequently to make predictions or decisions. ML models can be used in a wide variety of applications (e.g., medicine, email filtering, speech recognition, etc.) where it is difficult or unfeasible to develop conventional algorithms to perform the needed tasks.

3GPP TS 23.288 (v17.2.0) specifies NWDAF as the main NF for computing analytics based on ML models and classifies NWDAF into two logical functions: Analytics Logical Function (AnLF), which performs analytics procedures; and Model Training Logical Function (MTLF), which performs training and retraining of ML models used by the AnLF.

Many regions and countries have published related policies and requirements to control carbon release and promote energy efficiency. These policies have made energy efficiency a strategic priority for many mobile network operators (MNOs) around the world, from both cost and sustainability perspectives. Moreover, 3GPP has published various specifications related to network energy consumption and/or efficiency.

3GPP TS 21.866 (v15.0.0) identifies and studies key issues and potential solutions in defining energy efficiency Key Performance Indicators (KPIs) and energy efficiency optimization operations in existing and future 3GPP networks. 3GPP TS 28.554 (v17.8.0) and 28.310 (v17.4.0) define some energy efficiency KPIs for entire networks, sub-networks, sites, network slices, and network elements. Typically, these KPIs are used by MNOs to control their network energy expenses. 3GPP TR 28.813 (v17.0.0) and 32.972 (v17.0.0) describe network energy efficiency techniques such as dynamic energy saving state activation, more efficient radio resource management, etc.

These solutions are focused almost exclusively on energy efficiency of the network infrastructure elements, i.e., in NG-RAN and 5GC. Furthermore, although MDAF provides some analytics related to energy efficiency of network elements neither MDAF nor NWDAF support analytics related to service level energy efficiency.

However, there is a need for more granular monitoring and management of energy consumption and/or efficiency of applications or services running over the network, such as cloud gaming, video streaming, etc. For example, such information can be used to evaluate or improve sustainability at the service level. Some cloud providers (e.g., AWS) enable their customers to check the carbon emission of their services deployed in the provider's cloud.

Compared to a (non-mobile) cloud network, it is more difficult to measure the energy consumption or efficiency of a service in a communication network because the service traffic has an energy consumption footprint in the RAN (e.g., NG-RAN), CN (e.g., 5GC), and any transport network connecting the RAN and the CN. As such, it is difficult to determine energy consumed in each of these segments by a particular service, and to determine an overall service-level energy efficiency (or consumption) across all segments of the communication network.

3GPP TS 22.882 (v0.1.0) describes a technical study on energy efficiency as service criteria, with a goal of allowing users (e.g., end users and/or application services) to select energy efficiency criteria along with other network performance parameters for their services. Another goal is to expose systematic energy consumption or energy efficiency of the network to vertical customers. Although this document describes various use cases or scenarios, it does not specify solutions for achieving the stated goals for these use cases or scenarios.

Embodiments of the present disclosure address these and other problems, issues, and/or difficulties by techniques for managing or controlling energy consumption and/or efficiency on a service or application level in a communication network (e.g., 5G). For example, a new or existing NF can be arranged to receive service level energy efficiency requirements (e.g., directly from the service or from an entity in the communication network), parse the requirements, and obtain energy efficiency information (e.g., capabilities and current status) of network nodes or functions (NNFs) that are (or would be) involved in delivering and/or managing the service. The NF can translate these energy efficiency requirements to a set of energy efficiency polices that can be provided to the NNFs (including management functions) in the communication network, so that the requirements can be fulfilled during delivery of the service by the NNFs applying these policies. Moreover, the NF can continuously monitor and analyze the related energy efficiency information in the communication network, and modify the energy efficiency policies in use by the NNFs as needed.

In this manner, embodiments facilitate service level energy efficiency management and control in communication networks, which enables MNOs to meet their strategic priorities for network energy efficiency. Moreover, embodiments can be implemented based on existing 3GPP network architecture, which facilitates faster deployment and reduces deployment cost and/or complexity.

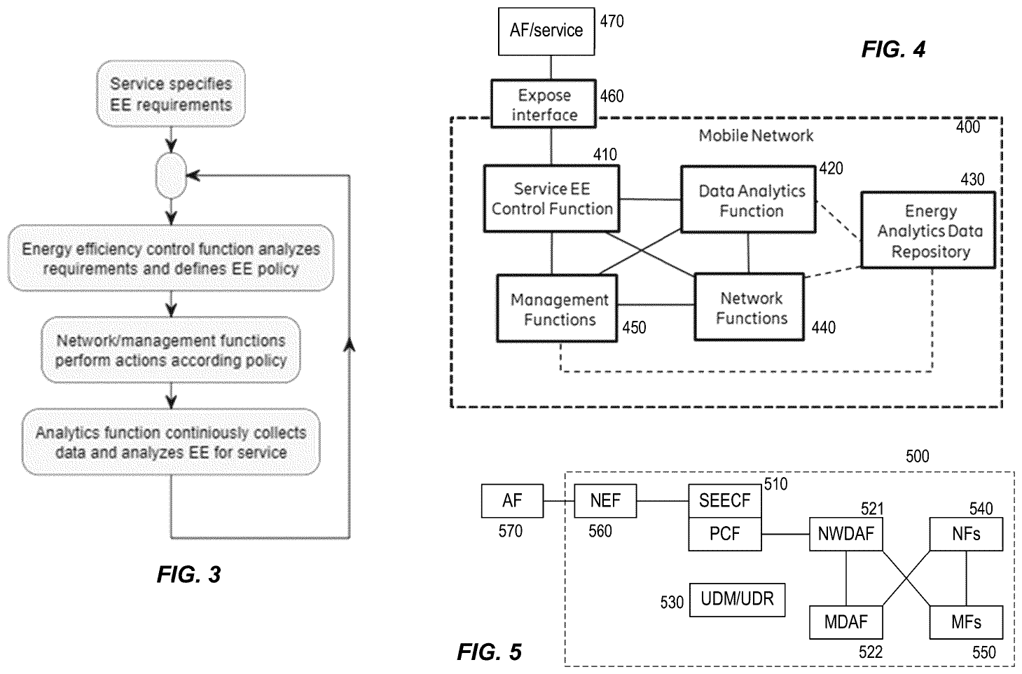

FIG. 3 shows a flow diagram of a procedure that illustrates various embodiments of the present disclosure at a high level. In this procedure, a service (e.g., Netflix) that is delivered over the network to end users (e.g., via UEs) specifies its service level Energy Efficiency (EE) requirements. The requirements can be communicated either dynamically through a network interface (e.g., NEF) or can be specified via a service level agreement (SLA). A control function for service energy efficiency in the communication network analyzes the service level EE requirements and current network EE information, such as current EE level and associated capabilities of NNFs (including management functions) that are (or would be) involved in delivering and/or managing the service. Based on this, the control function determines suitable EE management policies, which are communicated to the NNFs. Based on these EE management policies, the NNFs perform operations to deliver the service. The control function continuously collects relevant EE information from the communication network and performs analytics on the collected information. Based on the analytics, the control function can modify the EE management policies as needed to fulfill the service level EE requirements.

FIG. 4 shows a system-level block diagram for an exemplary implementation of various embodiments of the present disclosure in a communication network (400).

“Service” at the top refers to an application that is deployed inside or outside of a communication network (e.g., in a mobile edge cloud or in a public cloud) but can be accessed by the end users in the communication network. Services can interact with the communication network either directly (e.g., for trusted, in-network service) or via an exposed interface (460, e.g., NEF). In general, a service can represent any entity (e.g., application provider, developer, etc.) that provides EE requirements to the communication network, possibly together with other requirements such as quality-of-service (QoS) or quality-of-experience (QoE). For example, the service can be provided by an AF (470).

The Service-Level Energy Efficiency Control Function (SEECF, 410) is responsible for managing (e.g., creating, modifying, etc.) EE policies corresponding to the service-level EE requirements received from the service(s). SEECF performs these operations based on EE information collected from NFs (440) and management functions (MFs, 450, e.g., in OAM), analytics provided by the Data Analytics Function (420, e.g., NWDAF), and other relevant information.

NFs are physical/virtualized functions of the control plane or user plane in the 3GPP architecture that provide certain functional building blocks. FIG. 2 described above shows various NFs in a 5GC. In contrast, MFs control and manage the network, the NFs, and network nodes. Collectively, the NFs and network node are referred to network nodes or functions (NNFs). MFs may be responsible for control of some EE-related functions of the NNFs, e.g., enabling/disabling certain energy saving features.

The DAF collects service-related EE information from NFs and MFs, determines analytics based on this information, and provides EE analytics to SEECF. For example, the SEECF could subscribe to subsequent notifications by the DAF for a particular EE analytic, or the SEECF could request an EE analytic and receive it from the DAF in response. The Energy Analytics Data Repository (EADR, 430) stores the EE information collected from the NFs and MFs, as well as the EE analytics determined by the DAF.

FIG. 5 shows a system-level block diagram for another exemplary implementation of various embodiments of the present disclosure in a mobile network (500). In this implementation, the NEF (560) is a more specific example of the exposure interface (460) shown in FIG. 4, and provides access to the communication network for services provided by an AF (570).

The SEECF (510) can be implemented as a part of the PCF or an extension thereof. The NWDAF (521) and MDAF (522) are more specific examples of the DAF (420) shown in FIG. 4. The NWDAF provides EE analytics based on information from NFs (540) while the MDAF provides EE analytics based on information from MFs (550). EADR (430) shown in FIG. 4 can be implemented as part of the UDM/UDR (530), or in another storage repository in 5GC.

One difficulty in defining an EE metric at a service level in a communication network is that traffic data between end users and the service can occur from anywhere within the coverage of the communication network. Thus, energy consumption in the network due to this data traffic can be widely distributed in the communication network. Moreover, the energy consumption due to the service data traffic can be very dynamic according to the users' movements and change in service usage patterns.

In some embodiments, a service level EE metric EE_{S} can be defined as described below. One assumption is that the service is deployed in a central cloud, e.g., hosted by the service provider. The service level EE metric EE_{S} can be represented as:

$$E {E}_{S} = \frac{P M}{E {C}_{S}} , \qquad ( 1 )$$

where PM denotes performance metrics (e.g., traffic volume or latency, etc.) of service S and EC_{S} denotes the total communication network energy consumption attributed to service S in a predefined time period.

As a more specific example, the performance metric can be data volume (DV) transferred between the service end users and the service over the communication network during the time period. In this example, service level EE metric EE_{S} can be represented as:

$$E {E}_{S} = \frac{D V}{{EC}_{S}} . \qquad ( 2 )$$

In general, EC_{S} can be split into the following two components:

$$E {C}_{S} = {EC\_D}_{S} + {EC\_C}_{S} , \qquad ( 3 )$$

where EC_D_{S} denotes energy consumed by transferring data traffic in the communication network (i.e., user plane) and EC_C_{S} denotes energy consumed by control plane functions (e.g., SMF, AMF) that manage the flow of the data traffic. In a 3GPP network, the data traffic goes through the user plane of the RAN and CN, as well as the transport network connecting RAN and CN. The NNFs in the user plane (e.g., base stations, UPF) and transport nodes will consume EC_D_{S} in a direct relation to the DV for the service.

The control plane functions (e.g., AMF, SMF, etc.) also consume energy related to providing connectivity to the service. Unlike EC_D_{S}, however, EC_C_{S} has no direction relation to DV for the service. It is not easy to measure or calculate the energy consumption caused by a service in the control plane. Moreover, the inventors have recognized that the control plane contribution to service-level energy consumption is generally much lower than contribution by the user plane. Accordingly, the assumption EC_{S}≈EC_D_{S} is generally accurate and will be used herein.

In some embodiments, the total user plane energy consumption EC_D_{S} for a service is calculated over all data paths (dp) for the service as:

$${EC\_D}_{S} = {\sum }_{d p} E {C}_{s}^{d p} , where {EC}_{s}^{dp} \qquad ( 4 )$$

is the energy consumed along a single data path. In a 5G network, a data path can include a base station serving the user's UE, a serving UPF, and intermediate transport devices.

For some components in the communication network and cloud infrastructure, it may be very difficult to measure energy consumption of a DV of a particular service. This is the case in the RAN, which doesn't have service information for the data traffic that it carries. Nevertheless, energy consumed by a NNF during a specified period can be measured, with portions allocated to different services in a pro rata share according to their respective DVs through the NNF during the period.

In some embodiments, a service-level EE for the communication network can be calculated based on equation (2) above using the service-level energy consumption in all involved NNFs during a time period, as calculated in equation (4) above, and the total service-level DV during the time period. In other embodiments, a service-level EE for the communication network can be calculated based on service-level energy consumption

$$( E {C}_{s}^{d p} )$$

and data volume

$$( D {V}_{s}^{d p} )$$

in each user plane path, from which a service-level EE per user plane path

$$( E {E}_{s}^{d p} )$$

can be determined as:

$$E {E}_{S}^{d p} = \frac{D {V}_{s}^{d p}}{E {c}_{s}^{d p}} , \qquad ( 5 )$$

The service-level EE_{S} can be calculated by averaging these values for all the user plane paths:

$$E {E}_{S} = A V G ( E {E}_{s}^{d p} ) . \qquad ( 6 )$$

In various embodiments, each service-level requirement can include the following information elements:
Requirement Type, with “Energy Efficiency” or “EE” being used to identify a requirement for energy efficiency;
Service ID, for the service associated with the requirement;
Performance Metric, indicating a type of network performance (e.g., DV, latency, etc.) to which the EE requirement applies;
Required (or requested) EE level, which vary according to performance metric. For example, if the performance metric is DV, a required EE level could be X Mbytes/Joule.

In some embodiments, each service-level requirement can also include one or more of the following information elements:
IP Filter, to identify specific IP flows for the service; and
UE IDs, to identify specific UEs that are associated with the energy efficiency requests.

In various embodiments, the SEECF can maintain a service-level EE policy for the requesting service based on the service-level EE requirement, current network EE information and analytics from NWDAF/MDAF, EE capabilities of the network functions, and other related network or service information. The service-level EE policy can include one or more entries for the particular service, with each entry including an EE policy and corresponding NNFs to which the EE policy applies. As a more specific example, each policy entry can include (but is not limited to) one or more of the following information:
Service ID;
Performance metric;
EE level, which can vary for different user plane paths so long as the overall required (or requested) EE level is fulfilled.
IP filter;
UE IDs;
User plane path filter, which identifies the user plane paths to which the policy entry applies. As an example, a user plane path can be represented by a set of NNF identifiers such as {BS-1, UPF-1}.
NF filter, which identifies NFs (e.g., UPF-1, UPF-2, etc.) to which the policy entry applies, and can be used in combination with or separate from the user plane path filter field. For example, (UPF-1, UPF-2).

As mentioned above, DAF collects EE-related information from multiple sources including NFs, MFs, etc. Some examples of data collected by the DAF include:
Performance metric (e.g., DV) measured or collected by the NFs or MFs;
Energy consumption measured or collected by the NFs or MFs; and
EE measurement, e.g., at level of individual NNF.

The DAF can also provide predicted EE information and other analytics results, e.g., NFs or user plane path that could be optimized for EE. Some example analytics results provide by DAF include:
EE report, including measured or predicted EE value(s) and optionally any related statistics (e.g., standard deviation, min/max, etc.). The reported EE value(s) can be for the entire service, one or more service instances, one or more specific user plane paths, one or more specific NNFs, etc. The EE report can also include energy consumption values and/or performance metrics from which the reported EE value(s) are obtained.
EE recommendation, including recommended EE policy or actions, such as to decrease/increase EE of a specific NNF or user plane path. The SEECF can (but is not required to) base its EE policy determination on this recommended EE policy.

As mentioned before, the SEECF generates EE policies corresponding to the service-level EE requirements as well as other related information. The following describes an example embodiment of a procedure for generating EE policies corresponding to the service-level EE requirements. The inputs to this procedure are:
EE requirement (EEᵣ) provided by the AF.
Communication network topology of the coverage area that can access the service.
EE capability (e.g., the maximum and minimum EE) of NNFs in that topology.
Currently or historical EE of the service, or energy consumption and performance data for NNFs in the topology, which can be used to calculate the EE of the service.
   Given these inputs, the SEECF performs the following operations:
1. Determine a list of user plane paths D=(d₁, d₂, . . . , dₙ) from the network topology.
2. For each user plane path, retrieve EE value (ee_{d1}, ee_{d2}, . . . , ee_{dn}) from other function (e.g., DAF) or calculate according to received energy consumption and performance data.
3. Calculate current total EE value (eeₜₒₜₐₗ), i.e., the average EE value for all user plane paths according to equations (5)-(6) above.
4. If current total EE value is at least the service-level requirement EEᵣ (i.e., EEr is fulfilled), then all NNFs will use the current default EE policy. Exit.
5. Otherwise, when current total EE value is less than the service-level requirement EEᵣ (i.e., EEr is fulfilled):
   a. For each user plane path in D, calculate the difference between maximum EE value and the current EE value;
   b. Sort user plane paths in the order of the calculated differences;
   c. For each user plane path in D:
      i. Update target EE value to maximum EE value of the user plane path;
      ii. Calculate current total EE value (eeₜₒₜₐₗ) using the updated target EE value;
      iii. If eeₜₒₜₐₗ greater than EEᵣ, then go to operation 6;
      iv. Else continue operation 5c loop.
6. For each user plane path that has an updated target EE value, modify target EE value for each NNF in the user plane path according to the updated target EE value for the user plane path.
   The resulting output is an EE policy for each NNF of the involved user plane paths, which includes the target EE value for the NNF as well as other information discussed above.

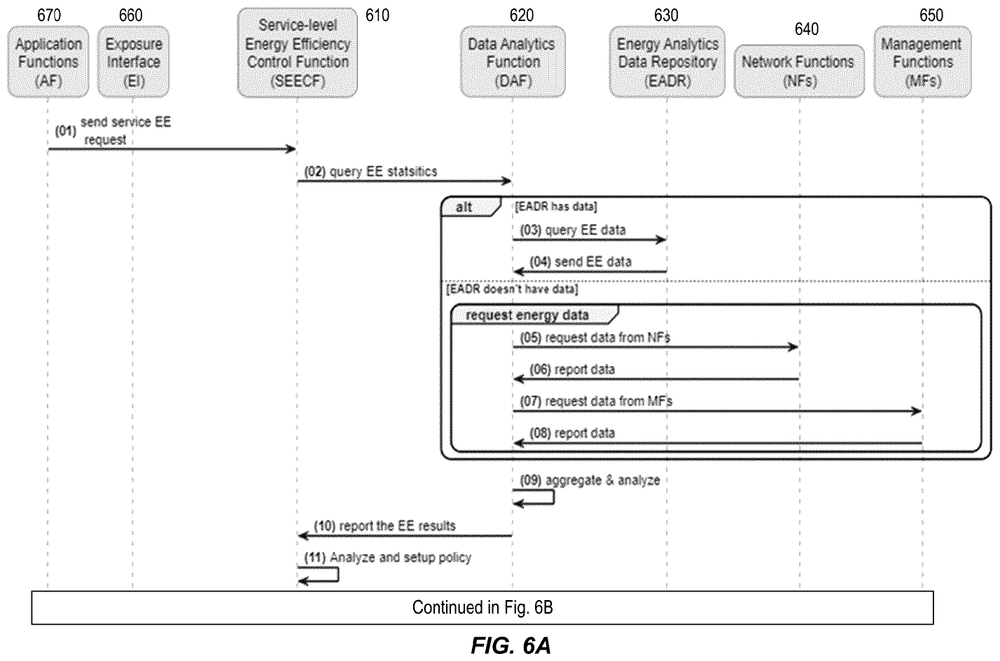

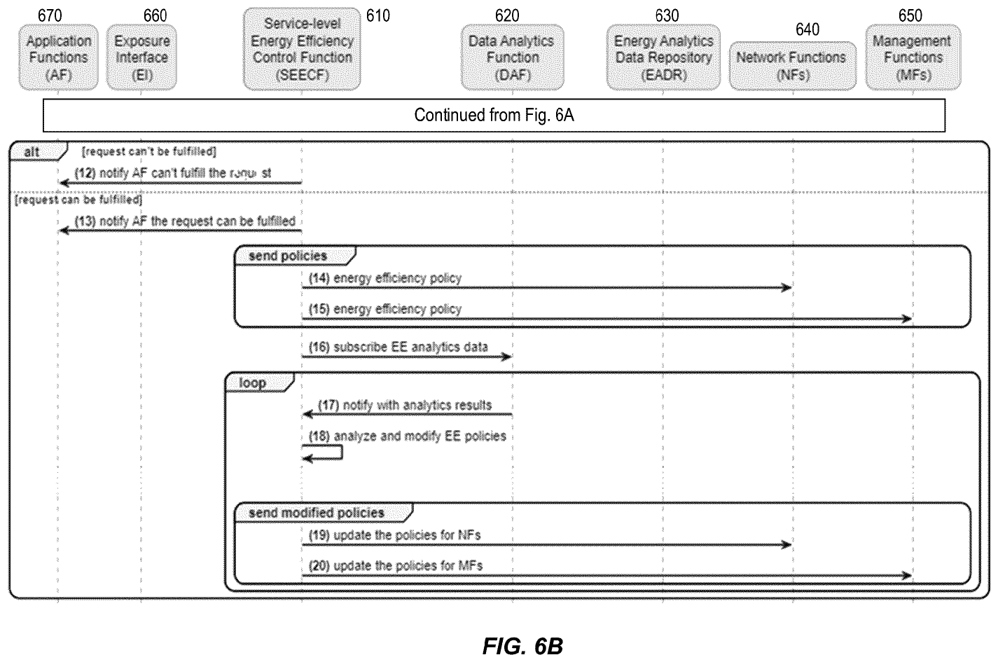

FIG. 6 (which includes FIGS. 6A-B) shows a signaling diagram of a procedure for managing EE policies in a communication network based on service-level EE requirements, according to various embodiments of the present disclosure. The signaling is between an AF (670, e.g., representing a service), a network exposure interface (660, e.g., NEF), an SEECF (610), a DAF (620, e.g., NWDAF/MDAF), an EADR (630), one or more NFs (640), and one or more MFs (650, e.g., in OAM). Although the operations shown in FIG. 6 are given numerical labels, this is intended to facilitate the following explanation rather than to require or imply any specific operational order, unless expressly stated otherwise.

In operation 1, the service (AF) sends an EE management request to the SEECF directly or via the exposure interface. The request includes a service ID, a performance metric, a required (or requested) EE level, and optionally other information described above such as IP filters, user plane path filters, etc. In operation 2, upon receiving the request, the SEECF queries the DAF for current (actual) or estimated EE information for the service in the communication network. The query includes the service ID and, if available, IP filter(s) or user plane path filter(s) that the DAF can use to identify the service.

In operation 3, the DAF queries the EADR for EE information for the identified service. If the service hasn't been initiated or accessed by end users in the communication network, there may be no actual EE information for the service. In such case, the DAF can request more generic EE information (e.g., for all services, for services of a particular type, etc.) from which it can estimate EE information for the service. In operation 4, the EADR returns the requested EE information.

Otherwise, operations 5-8 are performed if the EADR doesn't have the required information. In operation 5 the DAF requests the related NFs for the EE information and the NFs return the requested EE information in operation 6. Alternately, the NFs store the EE information in the EADR and notify the DAF to retrieve it from the EADR. Similarly, in operation 7 the DAF requests the MFs for the EE information and the MFs return the requested EE information in operation 8. Alternately, the MFs store the EE information in the EADR and notify the DAF to retrieve it from the EADR.

In operation 9, after receiving all needed EE information (e.g., energy consumption, performance metrics, service information, etc.), the DAF performs aggregation and analytics on this information and creates EE analytics results accordingly. In operation 10, the DAF sends the EE analytics results to the SEECF.

In operation 11, the SEECF checks the EE analytics results to determine whether the service-level EE requirements can be met by the communication network. If so, SEECF creates the EE policies accordingly based on the analytics results and all other related information, and notifies the AF in operation 13. Otherwise, if the service-level EE requirements cannot be fulfilled, the SEECF notifies the AF in operation 12.

Assuming that the service-level EE requirements can be fulfilled by the EE policies, in operations 14-15 the SEECF sends the EE policies to the corresponding NFs and MFs, respectively. In operation 16, the SEECF sends a request to DAF to subscribe to EE-related notifications. The content of the subscription request is similar to the query in operation 2, but can additionally specify notifications to be periodic or only when updated EE information is available.

In operation 17, the DAF provides the EE information to the SEECF in accordance with the subscription. In operation 18, the SEECF analyses the received EE information and modifies the EE policies as needed. In operations 19-20, the SEECF sends the modified EE policy to the corresponding NFs and MFs, respectively.

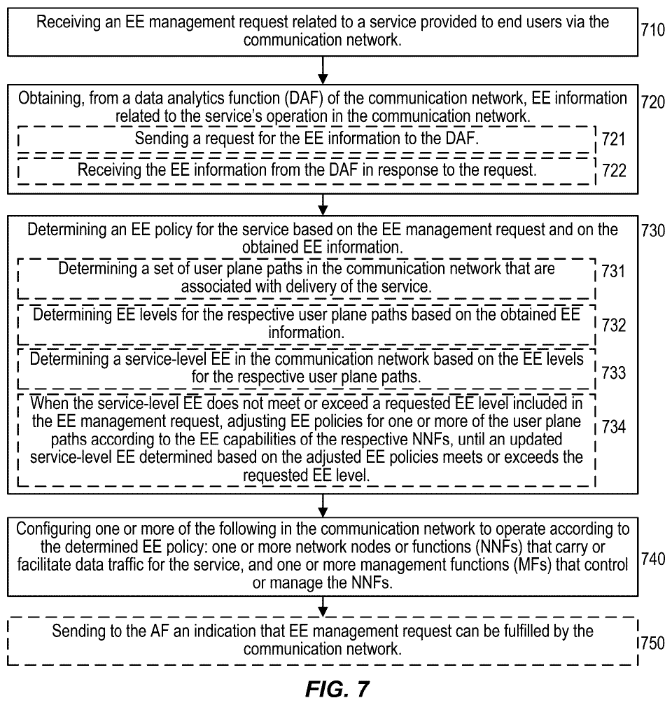

These embodiments described above can be further illustrated with reference to FIGS. 7-11, which depict exemplary methods (e.g., procedures) for an SEECF, a DAF, an EADR, an NNF, and an AF, respectively. Put differently, various features of the operations described below correspond to various embodiments described above. The exemplary methods shown in FIGS. 7-11 can be used cooperatively (e.g., with each other and with other procedures described herein) to provide benefits, advantages, and/or solutions to problems described herein. Although the exemplary methods are illustrated in FIGS. 7-11 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 7 illustrates an exemplary method (e.g., procedure) for an SEECF of a communication network (e.g., 5GC), according to various embodiments of the present disclosure. The exemplary method shown in FIG. 7 can be performed by an SEECF or a network node hosting an SEECF, such as described elsewhere herein.

The exemplary method can include the operations of block 710, where the SEECF can receive an EE management request related to a service provided to end users via the communication network. The exemplary method can also include the operations of block 720, where the SEECF can obtain, from a data analytics function (DAF) of the communication network, EE information related to the service's operation in the communication network. The exemplary method can also include the operations of block 730, where the SEECF can determine an EE policy for the service based on the EE management request and on the obtained EE information. The exemplary method can also include the operations of block 740, where the SEECF can configure one or more of the following in the communication network to operate according to the determined EE policy: one or more network nodes or functions (NNFs) that carry or facilitate data traffic for the service, and one or more management functions (MFs) that control or manage the NNFs.

In some embodiments, the EE management request includes one or more of the following: an identifier of the service; a requested EE level for delivery of the service by the communication network; and a network performance metric associated with the requested EE level. In some of these embodiments, the network performance metric associated with the requested EE level and/or the required EE level is data volume, throughput, or latency. In some of these embodiments, the EE management request also includes one or more of the following:
a user plane path filter that identifies user plane paths through the communication network that are associated with the service; and
an IP filter that identifies one or more IP flows associated with the service; and
one or more identifiers of UEs to which the EE management request applies.

In some of these embodiments, the determined EE policy includes one or more policy entries, with each policy entry including the following:
an indication of a portion of the communication network to which the policy entry applies;
a required EE level for the indicated portion of the communication network; and
an identifier of the service.

In some variants of these embodiments, the indication of the portion of the communication network to which the policy entry applies includes one or more of the following:
one or more identifiers of UEs;
a user plane path filter, which includes a set of NNF identifiers corresponding to a user plane path through the communication network; and
an NNF filter, which identifies one or more specific NNFs.

In some variants of these embodiments, each policy entry also includes an IP filter that identifies one or more IP flows associated with the service, and/or a network performance metric associated with the required EE level.

In some of these embodiments, the network performance metric associated with the requested EE level and/or the required EE level is data volume, throughput, or latency.

In some embodiments, obtaining the EE information from the DAF in block 720 includes the operations of sub-blocks 721-722, where the SEECF can send to the DAF a request for the EE information and receive the EE information from the DAF in response to the request. In some of these embodiments, the request for the EE information includes one or more of the following:
an identifier of the service;
an IP filter that identifies one or more IP flows associated with the service;
a user plane path filter that identifies user plane paths through the communication network that are associated with the service; and
a network node or function (NNF) filter that identifies NNFs in the communication network that are associated with the service.
   In some of these embodiments, the request for EE information in sub-block 721 is a subscription request that includes one or more conditions for receiving notifications, and the response is received in sub-block 722 based on the EE information meeting at least one of the conditions.

In some embodiments, the EE information obtained from the DAF in block 720 includes one or more of the following related to the service's operation in the communication network: one or more measured or predicted EE values; and one or more recommended EE policies or actions. In some of these embodiments, the EE information obtained from the DAF also includes one or more of the following from which the measured or predicted EE values and/or the recommended EE policies or actions were obtained: one or more network energy consumption values; and one or more network performance metrics.

In some embodiments, determining an EE policy for the service based on the EE management request and on the obtained EE information in block 730 includes the following operations, labelled with corresponding sub-block numbers:
(731) determining a set of user plane paths in the communication network that are associated with delivery of the service;
(732) determining EE levels for the respective user plane paths based on the obtained EE information; and
(733) determining a service-level EE in the communication network based on the EE levels for the respective user plane paths.

In some of these embodiments, determining an EE policy for the service based on the EE management request and on the obtained EE information in block 730 also includes the operations of sub-block 734, where when the service-level EE does not meet or exceed a requested EE level included in the EE management request, the SEECF can adjust EE policies for one or more of the user plane paths according to the EE capabilities of the respective NNFs, until an updated service-level EE determined based on the adjusted EE policies meets or exceeds the requested EE level.

In some embodiments, the EE management request is received from an application function (AF) configured to provide the service and the exemplary method can also include the operations of block 750, where the SEECF can send to the AF an indication that EE management request can be fulfilled by the communication network.

In addition, FIG. 8 illustrates an exemplary method (e.g., procedure) for a DAF configured to provide EE analytics in a communication network (e.g., 5GC), according to various embodiments of the present disclosure. The exemplary method shown in FIG. 8 can be performed by a DAF such as an NWDAF, MDAF, or combination thereof, or a network node hosting the same, such as described elsewhere herein.

The exemplary method can include the operations of block 810, where the DAF can receive, from an SEECF of the communication network, a request for EE information related to operation of a service in the communication network. The exemplary method can also include the operations of blocks 820-830, where the DAF can determine the EE information requested by the SEECF and send the determined EE information to the SEECF in response to the request.

In various embodiments, the request for EE information can include any of the contents described above in relation to SEECF embodiments.

In some embodiments, the determined EE information sent to the SEECF includes one or more of the following related to the service's operation in the communication network: one or more measured or predicted EE values; and one or more recommended EE policies or actions. In some of these embodiments, determining the EE information requested by the SEECF comprises one or more of the following operations, labelled with corresponding sub-block numbers:
(821) obtaining measured EE information associated with the service from one or more of the following: an energy analytics data repository (EADR), one or more network nodes or functions (NNFs) that carry or facilitate data traffic for the service, and one or more management functions (MFs) that control or manage the NNFs; and
(822) determining predicted EE information associated with the service based on past measured EE information, obtained from the EADR.

In some variants of these embodiments, the measured EE information (e.g., obtained in sub-block 821) includes one or more of the following associated with the service in the respective NNFs during a time period: network performance metrics, energy consumption metrics, and measured EE values. In some further variants, the network energy consumption metric associated with the service in each NNF is one of the following:
measured energy consumption for the service during the time period, or
a pro rata share of measured energy consumption for the NNF during the time period, according to data volume of the service.

In some of these embodiments, the determined EE information sent to the SEECF (e.g., in block 830) also includes one or more of the following from which the measured or predicted EE values and/or the recommended EE policies or actions were determined: one or more network energy consumption values, and one or more network performance metrics. In some embodiments, each of the measured or predicted EE values and each of the recommended EE policies or actions pertains to one of the following:
one or more instances of the service in the communication network,
one or more specific user plane paths in the communication network,
one or more specific NNFs in the communication network, or
all instances of the service and the entire communication network.

In some embodiments, the request for EE information (e.g., in block 810) is a subscription request that includes one or more conditions for receiving notifications, and the response is sent (e.g., in block 830) based on the determined EE information meeting at least one of the conditions.

In some embodiments, the DAF is an NWDAF. In other embodiments, the DAF is an MDAF.

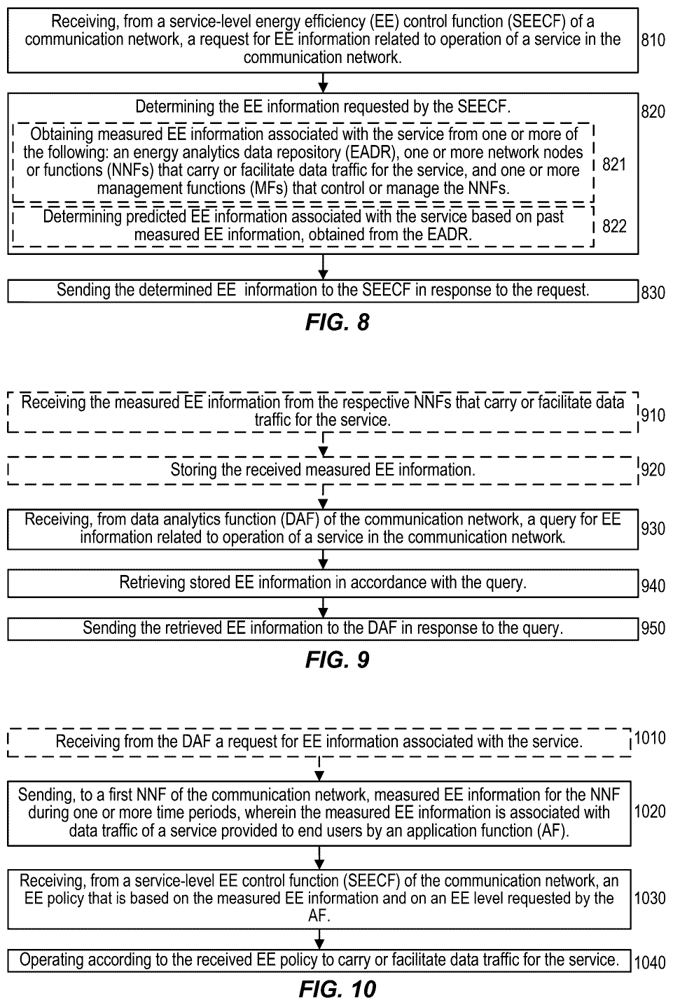

In addition, FIG. 9 illustrates an exemplary method (e.g., procedure) for an EADR of a communication network (e.g., 5GC), according to various embodiments of the present disclosure. The exemplary method shown in FIG. 9 can be performed by a UDM, UDR, or other type of network storage repository, or a network node hosting the same, such as described elsewhere herein.

The exemplary method can include the operations of block 930, where the EADR can receive, from a data analytics function (DAF) of the communication network, a query for EE information related to operation of a service in the communication network. The exemplary method can also include the operations of blocks 940-950, where the EADR can retrieve stored EE information in accordance with the query and send the retrieved EE information to the DAF in response to the query.

In some embodiments, the retrieved EE information includes measured EE information associated with the service during one or more of the following: a current time period, and one or more past time periods. In some of these embodiments, the measured EE information includes one or more of the following associated with the service in respective network nodes or functions (NNFs) that carry or facilitate data traffic for the service: network performance metrics, energy consumption metrics, and measured EE values. In some variants of these embodiments, each network energy consumption metric associated with the service in an NNF is one of the following:
measured energy consumption for the service in the NNF during a current or past time period, or
a pro rata share of measured energy consumption for the NNF during the current or past time period, according to data volume of the service.

In some of these embodiments, the exemplary method can also include the operations of blocks 910-920, where the EADR can receive the measured EE information from the respective NNFs that carry or facilitate data traffic for the service and store the received measured EE information. In such case, the stored information can be retrieved in block 930, as discussed above.

In some embodiments, the DAF a network data analytics function (NWDAF) or a management data analytics function (MDAF). In some embodiments, the EADR is part of one of the following associated with the communication network: a unified data management (UDM) function, or a unified data repository (UDR).

In addition, FIG. 10 illustrates an exemplary method (e.g., procedure) for an NNF configured for service-level EE management in a communication network (e.g., 5GC), according to various embodiments of the present disclosure. The exemplary method shown in FIG. 10 can be performed by any type of NNF configured for service-level EE management, such as described elsewhere herein.

The exemplary method can include the operations of block 1020, where the NNF can send, to a first NNF of the communication network, measured EE information for the NNF during one or more time periods. The measured EE information is associated with data traffic of a service provided to end users by an application function (AF). The exemplary method can also include the operations of block 1030, where the NNF can receive, from an SEECF of the communication network, an EE policy that is based on the measured EE information and on an EE level requested by the AF. The exemplary method can also include the operations of block 1040, where the NNF can operate according to the received EE policy to carry or facilitate data traffic for the service.

In some embodiments, the EE policy includes one or more policy entries, with each policy entry including the following:
an indication of a portion of the communication network to which the policy entry applies;
a required EE level for the indicated portion of the communication network; and
an identifier of the service.
   In some of these embodiments, the indication of the portion of the communication network to which the policy entry applies includes one or more of the following:
one or more identifiers of UEs;
a user plane path filter, which includes a set of NNF identifiers corresponding to a user plane path through the communication network; and
an NNF filter, which identifies one or more specific NNFs.
   In some of these embodiments, each policy entry also includes one or more of the following: an IP filter that identifies one or more IP flows associated with the service; and a network performance metric associated with the required EE level.

In some embodiments, the first NNF is a data analytics function (DAF) and the exemplary method can also include the operations of block 1010, where the NNF can receive from the DAF a request for EE information associated with the service. The measured EE information for the NNF is sent to the DAF in block 1020 in response to the request.

In other embodiments, the first NNF is an energy analytics data repository (EADR) of the communication network.

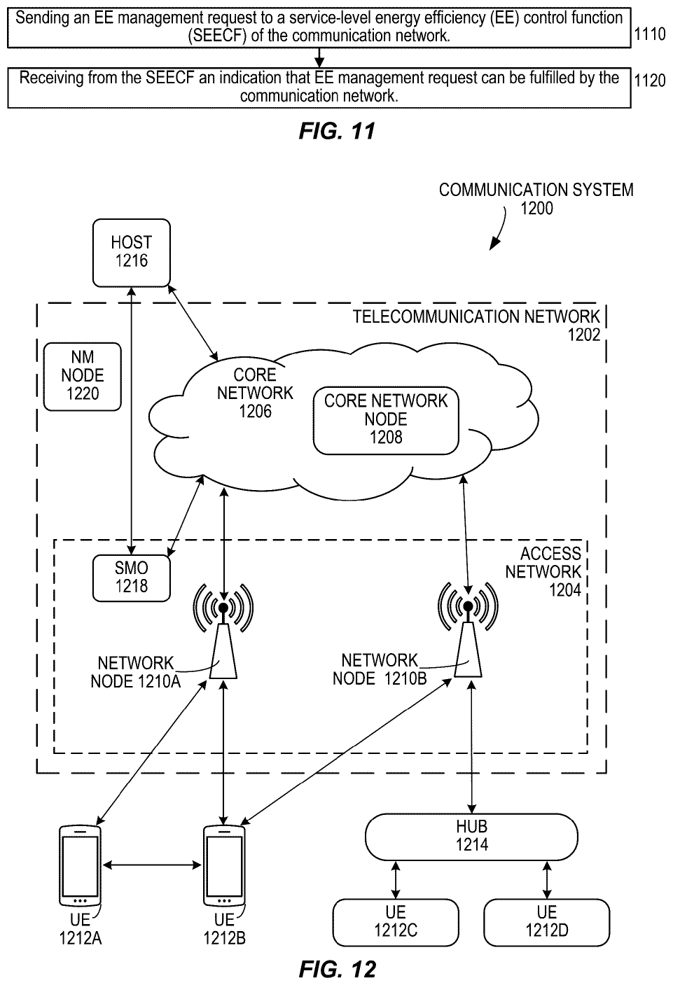

In addition, FIG. 11 illustrates an exemplary method (e.g., procedure) for an AF configured to provide a service to end users via a communication network (e.g., 5GC), according to various embodiments of the present disclosure. The exemplary method shown in FIG. 11 can be performed by any type of AF configured to provide service-level EE requirements to the communication network, such as described elsewhere herein.

The exemplary method can include the operations of block 1110, where the AF can send an EE management request to an SEECF of the communication network. The exemplary method can also include the operations of block 1120, where the AF can receive from the SEECF an indication that EE management request can be fulfilled by the communication network.

In some embodiments, the EE management request includes one or more of the following: an identifier of the service; a requested EE level for delivery of the service by the communication network; and a network performance metric associated with the requested EE level. In some embodiments, the EE management request also includes one or more of the following:
a user plane path filter that identifies user plane paths through the communication network that are associated with the service;
an IP filter that identifies one or more IP flows associated with the service; and
one or more identifiers of UEs to which the EE management request applies.

In some of these embodiments, the network performance metric associated with the requested EE level is data volume, throughput, or latency.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 12 shows an example of a communication system 1200 in accordance with some embodiments. In this example, communication system 1200 includes a telecommunication network 1202 that includes an access network 1204 (e.g., RAN) and a core network 1206, which includes one or more core network nodes 1208. In some embodiments, telecommunication network 1202 can also include one or more Network Management (NM) nodes 1220, which can be part of an operation support system (OSS), a business support system (BSS), and/or an OAM system. The NM nodes can monitor and/or control operations of other nodes in access network 1204 and core network 1206. Although not shown in FIG. 12, NM node 1220 is configured to communicate with other nodes in access network 1204 and core network 1206 for these purposes.

Access network 1204 includes one or more access network nodes, such as network nodes 1210a-b (one or more of which may be generally referred to as network nodes 1210), or any other similar 3GPP access node or non-3GPP access point. Network nodes 1210 facilitate direct or indirect connection of UEs, such as by connecting UEs 1212a-d (one or more of which may be generally referred to as UEs 1212) to core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1200 may include any number of wired or wireless networks, network nodes, UEs, and/or any other components or systems that may facilitate or participate in the communication of data and/or signals whether via wired or wireless connections. Communication system 1200 may include and/or interface with any type of communication, telecommunication, data, cellular, radio network, and/or other similar type of system.

UEs 1212 may be any of a wide variety of communication devices, including wireless devices arranged, configured, and/or operable to communicate wirelessly with network nodes 1210 and other communication devices. Similarly, network nodes 1210 are arranged, capable, configured, and/or operable to communicate directly or indirectly with UEs 1212 and/or with other network nodes or equipment in telecommunication network 1202 to enable and/or provide network access, such as wireless network access, and/or to perform other functions, such as administration in telecommunication network 1202.

In the depicted example, core network 1206 connects network nodes 1210 to one or more hosts, such as host 1216. These connections may be direct or indirect via one or more intermediary networks or devices. In other examples, network nodes may be directly coupled to hosts. Core network 1206 includes one or more core network nodes (e.g., 1208) that are structured with hardware and software components. Features of these components may be substantially similar to those described with respect to the UEs, network nodes, and/or hosts, such that the descriptions thereof are generally applicable to the corresponding components of core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1216 may be under the ownership or control of a service provider other than an operator or provider of access network 1204 and/or telecommunication network 1202, and may be operated by the service provider or on behalf of the service provider. Host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In some embodiments, access network 1204 can include a service management and orchestration (SMO) system or node 1218, which can monitor and/or control operations of the access network nodes 1210. This arrangement can be used, for example, when access network 1204 utilizes an Open RAN (O-RAN) architecture. SMO system 1218 can be configured to communicate with core network 1206 and/or host 1216, as shown in FIG. 12.

In some embodiments, one or more of host 1216, NM node 1220, and SMO system 1218 can be configured to perform various operations of exemplary methods (e.g., procedures) described above in relation to FIGS. 6-11.

As a whole, communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1202 is a cellular network that implements 3GPP standardized features. Accordingly, telecommunication network 1202 may support network slicing to provide different logical networks to different devices that are connected to telecommunication network 1202. For example, telecommunication network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1212 are configured to transmit and/or receive information without direct human interaction. For instance, a UE may be designed to transmit information to access network 1204 on a predetermined schedule, when triggered by an internal or external event, or in response to requests from access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1214 communicates with access network 1204 to facilitate indirect communication between one or more UEs (e.g., UE 1212c and/or 1212d) and network nodes (e.g., network node 1210b). In some examples, hub 1214 may be a controller, router, content source and analytics, or any of the other communication devices described herein regarding UEs. For example, hub 1214 may be a broadband router enabling access to core network 1206 for the UEs. As another example, hub 1214 may be a controller that sends commands or instructions to one or more actuators in the UEs. Commands or instructions may be received from the UEs, network nodes 1210, or by executable code, script, process, or other instructions in hub 1214. As another example, hub 1214 may be a data collector that acts as temporary storage for UE data and, in some embodiments, may perform analysis or other processing of the data. As another example, hub 1214 may be a content source. For example, for a UE that is a VR headset, display, loudspeaker or other media delivery device, hub 1214 may retrieve VR assets, video, audio, or other media or data related to sensory information via a network node, which hub 1214 then provides to the UE either directly, after performing local processing, and/or after adding additional local content. In still another example, hub 1214 acts as a proxy server or orchestrator for the UEs, in particular in if one or more of the UEs are low energy IoT devices.

Hub 1214 may have a constant/persistent or intermittent connection to network node 1210b. Hub 1214 may also allow for a different communication scheme and/or schedule between hub 1214 and UEs (e.g., UE 1212c and/or 1212d), and between hub 1214 and core network 1206. In other examples, hub 1214 is connected to core network 1206 and/or one or more UEs via a wired connection. Moreover, hub 1214 may be configured to connect to an M2M service provider over access network 1204 and/or to another UE over a direct connection. In some scenarios, UEs may establish a wireless connection with network nodes 1210 while still connected via hub 1214 via a wired or wireless connection. In some embodiments, hub 1214 may be a dedicated hub—that is, a hub whose primary function is to route communications to/from the UEs from/to network node 1210b. In other embodiments, hub 1214 may be a non-dedicated hub—that is, a device which is capable of operating to route communications between the UEs and network node 1210b, but which is additionally capable of operating as a communication start and/or end point for certain data channels.

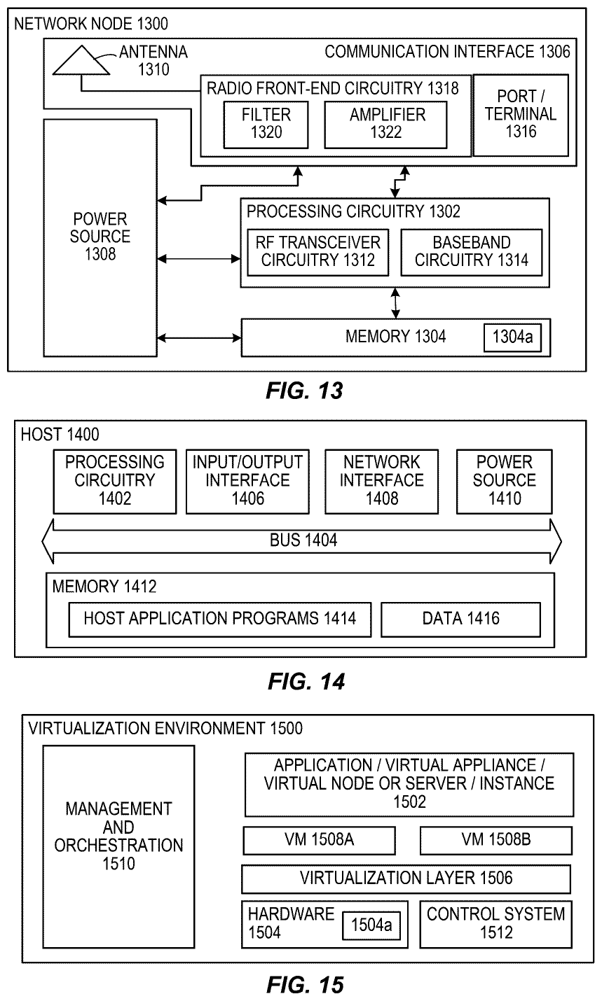

FIG. 13 shows a network node 1300 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

As a more specific example, one or more network nodes 1300 can be configured to host, or perform operations attributed to, an SEECF, a DAF (e.g., NWDAF), an EADR, or an NNF in the above descriptions of the exemplary methods (e.g., procedures) shown in FIGS. 6-10.

Network node 1300 includes processing circuitry 1302, memory 1304, communication interface 1306, and power source 1308. Network node 1300 may be composed of multiple physically separate components (e.g., a NodeB component and a RNC component, or a BTS component and a BSC component, etc.), which may each have their own respective components. In certain scenarios in which network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1300 may be configured to support multiple radio access technologies (RATs). In such embodiments, some components may be duplicated (e.g., separate memory 1304 for each RAT) and some components may be reused (e.g., antenna 1310 may be shared by different RATs). Network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

Processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as memory 1304, to provide network node 1300 functionality.

In some embodiments, processing circuitry 1302 includes a system on a chip (SOC). In some embodiments, processing circuitry 1302 includes one or more of radio frequency (RF) transceiver circuitry 1312 and baseband processing circuitry 1314. In some embodiments, RF transceiver circuitry 1312 and baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

Memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1302. Memory 1304 may store any suitable instructions, data, or information, including a computer program, software, an application including one or more of logic, rules, code, tables, and/or other instructions (collectively denoted computer program 1304a, which may be in the form of a computer program product) capable of being executed by processing circuitry 1302 and utilized by network node 1300. Memory 1304 may be used to store any calculations made by processing circuitry 1302 and/or any data received via communication interface 1306. In some embodiments, processing circuitry 1302 and memory 1304 is integrated.

Communication interface 1306 is used in wired or wireless communication of signaling and/or data between a network node, access network, and/or UE. As illustrated, communication interface 1306 comprises port(s)/terminal(s) 1316 to send and receive data, for example to and from a network over a wired connection. Communication interface 1306 also includes radio front-end circuitry 1318 that may be coupled to, or in certain embodiments a part of, antenna 1310. Radio front-end circuitry 1318 comprises filters 1320 and amplifiers 1322. Radio front-end circuitry 1318 may be connected to an antenna 1310 and processing circuitry 1302. The radio front-end circuitry may be configured to condition signals communicated between antenna 1310 and processing circuitry 1302. Radio front-end circuitry 1318 may receive digital data that is to be sent out to other network nodes or UEs via a wireless connection. Radio front-end circuitry 1318 may convert the digital data into a radio signal having the appropriate channel and bandwidth parameters using a combination of filters 1320 and/or amplifiers 1322. The radio signal may then be transmitted via antenna 1310. Similarly, when receiving data, antenna 1310 may collect radio signals which are then converted into digital data by radio front-end circuitry 1318. The digital data may be passed to processing circuitry 1302. In other embodiments, the communication interface may comprise different components and/or different combinations of components.

In certain alternative embodiments, network node 1300 does not include separate radio front-end circuitry 1318, instead, processing circuitry 1302 includes radio front-end circuitry and is connected to antenna 1310. Similarly, in some embodiments, all or some of RF transceiver circuitry 1312 is part of communication interface 1306. In still other embodiments, communication interface 1306 includes one or more ports or terminals 1316, radio front-end circuitry 1318, and RF transceiver circuitry 1312, as part of a radio unit (not shown), and communication interface 1306 communicates with baseband processing circuitry 1314, which is part of a digital unit (not shown).

Antenna 1310 may include one or more antennas, or antenna arrays, configured to send and/or receive wireless signals. Antenna 1310 may be coupled to radio front-end circuitry 1318 and may be any type of antenna capable of transmitting and receiving data and/or signals wirelessly. In certain embodiments, antenna 1310 is separate from network node 1300 and connectable to network node 1300 through an interface or port.

Antenna 1310, communication interface 1306, and/or processing circuitry 1302 may be configured to perform any receiving operations and/or certain obtaining operations described herein as being performed by the network node. Any information, data and/or signals may be received from a UE, another network node and/or any other network equipment. Similarly, antenna 1310, communication interface 1306, and/or processing circuitry 1302 may be configured to perform any transmitting operations described herein as being performed by the network node. Any information, data and/or signals may be transmitted to a UE, another network node and/or any other network equipment.

Power source 1308 provides power to the various components of network node 1300 in a form suitable for the respective components (e.g., at voltage and current levels needed for each component). Power source 1308 may further comprise, or be coupled to, power management circuitry to supply the components of network node 1300 with power for performing the functionality described herein. For example, network node 1300 may be connectable to an external power source (e.g., the power grid, an electricity outlet) via an input circuitry or interface such as an electrical cable, whereby the external power source supplies power to power circuitry of power source 1308. As a further example, power source 1308 may comprise a source of power in the form of a battery or battery pack which is connected to, or integrated in, power circuitry. The battery may provide backup power should the external power source fail.

Embodiments of network node 1300 may include additional components beyond those shown in FIG. 13 for providing certain aspects of the network node's functionality, including any of the functionality described herein and/or any functionality necessary to support the subject matter described herein. For example, network node 1300 may include user interface equipment to allow input of information into network node 1300 and to allow output of information from network node 1300. This may allow a user to perform diagnostic, maintenance, repair, and other administrative functions for network node 1300.

FIG. 14 is a block diagram of a host 1400, which may be an embodiment of host 1216 of FIG. 12, in accordance with various aspects described herein. As used herein, host 1400 may be or comprise various combinations hardware and/or software, including a standalone server, a blade server, a cloud-implemented server, a distributed server, a virtual machine, container, or processing resources in a server farm. Host 1400 may provide one or more services to one or more UEs.

Host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIG. 13, such that the descriptions thereof are generally applicable to the corresponding components of host 1400.

Memory 1412 may include one or more computer programs including one or more host application programs 1414 and data 1416, which may include user data, e.g., data generated by a UE for host 1400 or data generated by host 1400 for a UE. Embodiments of host 1400 may utilize only a subset or all of the components shown. Host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1414 may also provide for user authentication and licensing checks and may periodically report health, routes, and content availability to a central node, such as a device in or on the edge of a core network. Accordingly, host 1400 may select and/or indicate a different host for over-the-top services for a UE. Host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In some embodiments, host 1400 can be configured to perform various operations of exemplary methods (e.g., procedures) performed by an AF as described above in relation to the exemplary methods (e.g., procedures) shown in FIGS. 6 and 11.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in virtualization environment 1500 to implement some of the features, functions, and/or benefits of some of the embodiments disclosed herein.

For example, various NFs (or portions thereof) described herein in relation to other figures can be implemented as virtual network functions 1502 in virtualization environment 1500. As a more specific example, an SEECF, an DAF, an EADR, and an NNF can be implemented as virtual network functions 1502 in virtualization environment 1500.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a-b (one or more of which may be generally referred to as VMs 1508), and/or perform any of the functions, features and/or benefits described in relation with some embodiments described herein. Virtualization layer 1506 may present a virtual operating platform that appears like networking hardware to VMs 1508.

VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1508 may be a software implementation of a physical machine that runs programs as if they were executing on a physical, non-virtualized machine. Each VM 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of hardware 1504 and corresponds to application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

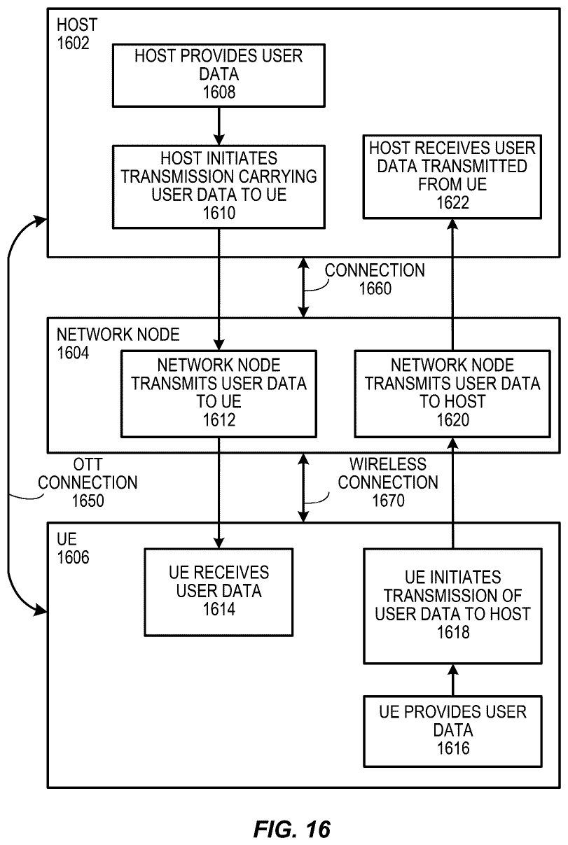

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1212a of FIG. 12), network node (such as network node 1210a of FIG. 12 and/or network node 1300 of FIG. 13), and host (such as host 1216 of FIG. 12 and/or host 1400 of FIG. 14) discussed in the preceding paragraphs will now be described with reference to FIG. 16.

Like host 1400, embodiments of host 1602 include hardware, such as a communication interface, processing circuitry, and memory. Host 1602 also includes software, which is stored in or accessible by host 1602 and executable by the processing circuitry. The software includes a host application that may be operable to provide a service to a remote user, such as UE 1606 connecting via an over-the-top (OTT) connection 1650 extending between UE 1606 and host 1602. In providing the service to the remote user, a host application may provide user data which is transmitted using OTT connection 1650.

Network node 1604 includes hardware enabling it to communicate with host 1602 and UE 1606. Connection 1660 may be direct or pass through a core network (like core network 1206 of FIG. 12) and/or one or more other intermediate networks, such as one or more public, private, or hosted networks. For example, an intermediate network may be a backbone network or the Internet.

UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of host 1602. In host 1602, an executing host application may communicate with the executing client application via OTT connection 1650 terminating at UE 1606 and host 1602. In providing the service to the user, the UE's client application may receive request data from the host's host application and provide user data in response to the request data. OTT connection 1650 may transfer both the request data and the user data. The UE's client application may interact with the user to generate the user data that it provides to the host application through OTT connection 1650.

OTT connection 1650 may extend via a connection 1660 between host 1602 and network node 1604 and via a wireless connection 1670 between network node 1604 and UE 1606 to provide the connection between host 1602 and UE 1606. Connection 1660 and wireless connection 1670, over which OTT connection 1650 may be provided, have been drawn abstractly to illustrate the communication between host 1602 and UE 1606 via network node 1604, without explicit reference to any intermediary devices and the precise routing of messages via these devices.

As an example of transmitting data via OTT connection 1650, in step 1608, host 1602 provides user data, which may be performed by executing a host application. In some embodiments, the user data is associated with a particular human user interacting with UE 1606. In other embodiments, the user data is associated with a UE 1606 that shares data with host 1602 without explicit human interaction. In step 1610, host 1602 initiates a transmission carrying the user data towards UE 1606. Host 1602 may initiate the transmission responsive to a request transmitted by UE 1606. The request may be caused by human interaction with UE 1606 or by operation of the client application executing on UE 1606. The transmission may pass via network node 1604, in accordance with the teachings of the embodiments described throughout this disclosure. Accordingly, in step 1612, network node 1604 transmits to UE 1606 the user data that was carried in the transmission that host 1602 initiated, in accordance with the teachings of the embodiments described throughout this disclosure. In step 1614, UE 1606 receives the user data carried in the transmission, which may be performed by a client application executed on UE 1606 associated with the host application executed by host 1602.

In some examples, UE 1606 executes a client application which provides user data to host 1602. The user data may be provided in reaction or response to the data received from host 1602. Accordingly, in step 1616, UE 1606 may provide user data, which may be performed by executing the client application. In providing the user data, the client application may further consider user input received from the user via an input/output interface of UE 1606. Regardless of how the user data was provided, UE 1606 initiates, in step 1618, transmission of the user data towards host 1602 via network node 1604. In step 1620, in accordance with the teachings of the embodiments described throughout this disclosure, network node 1604 receives user data from UE 1606 and initiates transmission of the received user data towards host 1602. In step 1622, host 1602 receives the user data carried in the transmission initiated by UE 1606.

One or more of the various embodiments improve the performance of OTT services provided to UE 1606 using OTT connection 1650, in which wireless connection 1670 forms the last segment. More precisely, embodiments facilitate service level energy efficiency management and control in communication networks, which enables mobile network operators (MNOs) to meet their strategic priorities for network energy efficiency (EE). Moreover, embodiments can be implemented based on existing 3GPP network architecture, which facilitates faster deployment and reduces deployment cost and/or complexity. Furthermore, embodiments facilitate energy-efficient delivery of OTT services via communication networks, which increases the value of such OTT services to end users and service providers.

In an example scenario, factory status information may be collected and analyzed by host 1602. As another example, host 1602 may process audio and video data which may have been retrieved from a UE for use in creating maps. As another example, host 1602 may collect and analyze real-time data to assist in controlling vehicle congestion (e.g., controlling traffic lights). As another example, host 1602 may store surveillance video uploaded by a UE. As another example, host 1602 may store or control access to media content such as video, audio, VR or AR which it can broadcast, multicast or unicast to UEs. As other examples, host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 1650 between host 1602 and UE 1606, in response to variations in the measurement results. The measurement procedure and/or the network functionality for reconfiguring the OTT connection may be implemented in software and hardware of host 1602 and/or UE 1606. In some embodiments, sensors (not shown) may be deployed in or in association with other devices through which OTT connection 1650 passes; the sensors may participate in the measurement procedure by supplying values of the monitored quantities exemplified above, or supplying values of other physical quantities from which software may compute or estimate the monitored quantities. The reconfiguring of OTT connection 1650 may include message format, retransmission settings, preferred routing etc.; the reconfiguring need not directly alter the operation of network node 1604. Such procedures and functionalities may be known and practiced in the art. In certain embodiments, measurements may involve proprietary UE signaling that facilitates measurements of throughput, propagation times, latency, and the like, by host 1602. The measurements may be implemented in that software causes messages to be transmitted, in particular empty or ‘dummy’ messages, using OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Example embodiments of the techniques and apparatus described herein include, but are not limited to, the following enumerated embodiments:
A1. A method for a service-level energy efficiency (EE) control function (SEECF) of a communication network, the method comprising:
   receiving an EE management request from an application function (AF) configured to provide a service to end users via the communication network;
   obtaining, from a data analytics function (DAF) of the communication network, EE information related to the service's operation in the communication network;
   determining an EE policy for the service based on the EE management request and on the obtained EE information; and
   configuring one or more of the following in the communication network to operate according to the determined EE policy: one or more network nodes or functions (NNFs) that carry or facilitate data traffic for the service, and one or more management functions (MFs) that control or manage the NNFs.
A2. The method of embodiment A1, wherein the EE management request includes one or more of the following:
   an identifier of the service;
   a requested EE level for delivery of the service by the communication network; and
   a network performance metric associated with the requested EE level.
A3. The method of embodiment A2, wherein the EE management request also includes one or more of the following:
   a user plane path filter that identifies user plane paths through the communication network that are associated with the service; and
   an Internet Protocol (IP) filter that identifies one or more IP flows associated with the service; and
   one or more identifiers of user equipment (UE) to which the EE management request applies.
A4. The method of any of embodiments A2-A3, wherein the determined EE policy includes one or more policy entries, with each policy entry including the following:
   an indication of a portion of the communication network to which the policy entry applies;
   a required EE level for the indicated portion of the communication network; and
   an identifier of the service.
A5. The method of embodiment A4, wherein the indication of the portion of the communication network to which the policy entry applies includes one or more of the following:
   one or more identifiers of user equipment (UE);
   a user plane path filter, which includes a set of NNF identifiers corresponding to a user plane path through the communication network; and
   an NNF filter, which identifies one or more specific NNFs.
A6. The method of any of embodiments A4-A5, wherein each policy entry also includes one or more of the following:
   an Internet Protocol (IP) filter that identifies one or more IP flows associated with the service; and
   a network performance metric associated with the required EE level.
A6a. The method of any of embodiments A2-A6, wherein the network performance metric associated with the requested EE level and/or the required EE level is one of the following: data volume, or latency.
A7. The method of any of embodiments A1-A6, wherein obtaining the EE information from the DAF comprises:
   sending, to the DAF, a request for the EE information; and
   receiving the EE information from the DAF in response to the request.
A7a. The method of embodiment A7, wherein the request for the EE information includes one or more of the following:
   an identifier of the service;
   an Internet Protocol (IP) filter that identifies one or more IP flows associated with the service;
   a user plane path filter that identifies user plane paths through the communication network that are associated with the service; and
   a network node or function (NNF) filter that identifies NNFs in the communication network that are associated with the service.
A7b. The method of any of embodiments A7-A7a, wherein:
   the request for EE information is a subscription request that includes one or more conditions for receiving notifications; and
   the response is received based on the EE information meeting at least one of the conditions.
A8. The method of any of embodiments A1-A7b, wherein the EE information obtained from the DAF includes one or more of the following related to the service's operation in the communication network:
   one or more measured or predicted EE values; and
   one or more recommended EE policies or actions.
A9. The method of claim A8, wherein the EE information obtained from the DAF also includes one or more of the following from which the measured or predicted EE values and/or the recommended EE policies or actions were obtained: one or more network energy consumption values; and one or more network performance metrics.
A10. The method of any of embodiments A8-A9, wherein each of the measured or predicted EE values and each of the recommended EE policies or actions pertains to one of the following:
   one or more instances of the service in the communication network,
   one or more specific user plane paths in the communication network,
   one or more specific NNFs in the communication network, or
   all instances of the service and the entire communication network.
A11. The method of any of embodiments A1-A10, wherein determining an EE policy for the service based on the EE management request and on the obtained EE information comprises:
   determining a set of user plane paths in the communication network that are associated with delivery of the service;
   determining EE levels for the respective user plane paths based on the obtained EE information; and
   determining a service-level EE in the communication network based on the EE levels for the respective user plane paths.
A12. The method of embodiment A11, wherein determining an EE policy for the service based on the EE management request and on the obtained EE information further comprises, when the service-level EE does not meet or exceed a requested EE level included in the EE management request, adjusting EE policies for one or more of the user plane paths according to the EE capabilities of the respective NNFs, until an updated service-level EE determined based on the adjusted EE policies meets or exceeds the requested EE level.
A13. The method of any of embodiments A1-A12, further comprising sending to the AF an indication that EE management request can be fulfilled by the communication network.
B1. A method for a data analytics function (DAF) configured to provide energy efficiency (EE) analytics in a communication network, the method comprising:
   receiving, from a service-level energy efficiency (EE) control function (SEECF) of the communication network, a request for EE information related to operation of a service in the communication network;
   determining the EE information requested by the SEECF; and
   sending the determined EE information to the SEECF in response to the request.
B2. The method of embodiment B1, wherein the request for the EE information includes one or more of the following:
   an identifier of the service;
   an Internet Protocol (IP) filter that identifies one or more IP flows associated with the service;
   a user plane path filter that identifies user plane paths through the communication network that are associated with the service; and
   a network node or function (NNF) filter that identifies NNFs in the communication network that are associated with the service.
B3. The method of any of embodiments B1-B2, wherein the determined EE information sent to the SEECF includes one or more of the following related to the service's operation in the communication network:
   one or more measured or predicted EE values; and
   one or more recommended EE policies or actions.
B4. The method of embodiment B3, wherein determining the EE information requested by the SEECF comprises one or more of the following:
   obtaining measured EE information associated with the service from one or more of the following: an energy analytics data repository (EADR), one or more network nodes or functions (NNFs) that carry or facilitate data traffic for the service, and one or more management functions (MFs) that control or manage the NNFs; and
   determining predicted EE information associated with the service based on past measured EE information, obtained from the EADR.
B5. The method of embodiment B4, wherein the measured EE information includes one or more of the following associated with the service in the respective NNFs during a time period: network performance metrics, energy consumption metrics, and measured EE values.
B6. The method of embodiment B5, wherein the network energy consumption metric associated with the service in each NNF is one of the following:
   measured energy consumption for the service during the time period, or
   a pro rata share of measured energy consumption for the NNF during the time period, according to data volume of the service.
B7. The method of any of embodiments B3-B6, wherein the determined EE information sent to the SEECF also includes one or more of the following from which the measured or predicted EE values and/or the recommended EE policies or actions were determined: one or more network energy consumption values, and one or more network performance metrics.
B8. The method of any of embodiments B3-B7, wherein each of the measured or predicted EE values and each of the recommended EE policies or actions pertains to one of the following:
   one or more instances of the service in the communication network,
   one or more specific user plane paths in the communication network,
   one or more specific NNFs in the communication network, or
   all instances of the service and the entire communication network.
B9. The method of any of embodiments B1-B8, wherein:
   the request for EE information is a subscription request that includes one or more conditions for receiving notifications; and
   the response is sent based on the determined EE information meeting at least one of the conditions.
B10. The method of any of embodiments B1-B9, wherein the DAF is one of the following: a network data analytics function (NWDAF), or a management data analytics function (MDAF).
C1. A method for an energy analytics data repository (EADR) of a communication network, the method comprising:
   receiving, from a data analytics function (DAF) of the communication network, a query for EE information related to operation of a service in the communication network;
   retrieving stored EE information in accordance with the query; and
   sending the retrieved EE information to the DAF in response to the query.
C2. The method of embodiment C1, wherein the retrieved EE information includes measured EE information associated with the service during one or more of the following: a current time period, and one or more past time periods.
C3. The method of embodiment C2, wherein the measured EE information includes one or more of the following associated with the service in respective network nodes or functions (NNFs) that carry or facilitate data traffic for the service: network performance metrics, energy consumption metrics, and measured EE values.
C4. The method of embodiment C3, wherein each network energy consumption metric associated with the service in an NNF is one of the following:
   measured energy consumption for the service in the NNF during a current or past time period, or
   a pro rata share of measured energy consumption for the NNF during the current or past time period, according to data volume of the service.
C5. The method of any of embodiments C1-C4, further comprising:
   receiving the measured EE information from the respective NNFs that carry or facilitate data traffic for the service; and
   storing the received measured EE information.
C6. The method of any of embodiments C1-C5, wherein one or more of the following applies:
   the DAF is one of the following: a network data analytics function (NWDAF), or a management data analytics function 500 (MDAF); and
   the EADR is part of one of the following associated with the communication network: a unified data management (UDM) function, or a unified data repository (UDR).
D1. A method for a network node or function (NNF) configured for service-level energy efficiency (EE) management in a communication network, the method comprising:
   sending, to a first NNF of the communication network, measured EE information for the NNF during one or more time periods, wherein the measured EE information is associated with data traffic of a service provided to end users by an application function (AF);
   receiving, from a service-level EE control function (SEECF) of the communication network, an EE policy that is based on the measured EE information and on an EE level requested by the AF; and
   operating according to the received EE policy to carry or facilitate data traffic for the service.
D2. The method of any of embodiments A2-A3, wherein the EE policy includes one or more policy entries, with each policy entry including the following:
   an indication of a portion of the communication network to which the policy entry applies;
   a required EE level for the indicated portion of the communication network; and
   an identifier of the service.
D3. The method of embodiment D2, wherein the indication of the portion of the communication network to which the policy entry applies includes one or more of the following:
   one or more identifiers of user equipment (UEs);
   a user plane path filter, which includes a set of NNF identifiers corresponding to a user plane path through the communication network; and
   an NNF filter, which identifies one or more specific NNFs.
D4. The method of any of embodiments D2-D3, wherein each policy entry also includes one or more of the following:
   an Internet Protocol (IP) filter that identifies one or more IP flows associated with the service; and
   a network performance metric associated with the required EE level.
D5. The method of any of embodiments D1-D4, wherein:
   the first NNF is a data analytics function (DAF);
   the method further comprises receiving from the DAF a request for EE information associated with the service; and
   the measured EE information for the NNF is sent to the DAF in response to the request.
D6. The method of any of embodiments D1-D4, wherein the first NNF is an energy analytics data repository (EADR) of the communication network.
E1. A method for an application function (AF) configured to provide a service to end users via a communication network, the method comprising:
   sending an EE management request to a service-level energy efficiency (EE) control function (SEECF) of the communication network; and
   receiving from the SEECF an indication that EE management request can be fulfilled by the communication network.
E2. The method of embodiment E1, wherein the EE management request includes one or more of the following:
   an identifier of the service;
   a requested EE level for delivery of the service by the communication network; and
   a network performance metric associated with the requested EE level.
E3. The method of embodiment E2, wherein the EE management request also includes one or more of the following:
   a user plane path filter that identifies user plane paths through the communication network that are associated with the service;
   an Internet Protocol (IP) filter that identifies one or more IP flows associated with the service; and
   one or more identifiers of user equipment (UE) to which the EE management request applies.
E4. The method of any of embodiments E2-E3, wherein the network performance metric associated with the requested EE level is one of the following: data volume, or latency.
F1. A service-level energy efficiency (EE) control function (SEECF) of a communication network, wherein:
   the SEECF is implemented by communication interface circuitry and processing circuitry that are operably coupled; and
   the processing circuitry and interface circuitry are configured to perform operations corresponding to any of the methods of embodiments A1-A13.
F2. A service-level energy efficiency (EE) control function (SEECF) of a communication network, the SEECF being configured to perform operations corresponding to any of the methods of embodiments A1-A13.
F3. A non-transitory, computer-readable medium storing computer-executable instructions that, when executed by processing circuitry associated with a service-level energy efficiency (EE) control function (SEECF) of a communication network, configure the SEECF to perform operations corresponding to any of the methods of embodiments A1-A13.
F4. A computer program product comprising computer-executable instructions that, when executed by processing circuitry associated with a service-level energy efficiency (EE) control function (SEECF) of a communication network, configure the SEECF to perform operations corresponding to any of the methods of embodiments A1-A13.
G1. A data analytics function (DAF) configured to provide energy efficiency (EE) analytics in a communication network, wherein:
   the DAF is implemented by communication interface circuitry and processing circuitry that are operably coupled; and
   the processing circuitry and interface circuitry are configured to perform operations corresponding to any of the methods of embodiments B1-B10.
G2. A data analytics function (DAF) configured to provide energy efficiency (EE) analytics in a communication network, the DAF being further configured to perform operations corresponding to any of the methods of embodiments B1-B10.
G3. A non-transitory, computer-readable medium storing computer-executable instructions that, when executed by processing circuitry associated with a data analytics function (DAF) configured to provide energy efficiency (EE) analytics in a communication network, configure DAF to perform operations corresponding to any of the methods of embodiments B1-B10.
G4. A computer program product comprising computer-executable instructions that, when executed by processing circuitry associated with a data analytics function (DAF) configured to provide energy efficiency (EE) analytics in a communication network, configure DAF to perform operations corresponding to any of the methods of embodiments B1-B10.
H1. An energy analytics data repository (EADR) of a communication network, wherein:
   the EADR is implemented by communication interface circuitry and processing circuitry that are operably coupled; and
   the processing circuitry and interface circuitry are configured to perform operations corresponding to any of the methods of embodiments C1-C6.
H2. An energy analytics data repository (EADR) of a communication network, the EADR being configured to perform operations corresponding to any of the methods of embodiments C1-C6.
H3. A non-transitory, computer-readable medium storing computer-executable instructions that, when executed by processing circuitry associated with an energy analytics data repository (EADR) of a communication network, configure the EADR to perform operations corresponding to any of the methods of embodiments C1-C6.
H4. A computer program product comprising computer-executable instructions that, when executed by processing circuitry associated with an energy analytics data repository (EADR) of a communication network, configure the EADR to perform operations corresponding to any of the methods of embodiments C1-C6.
I1. A network node or function (NNF) configured for service-level energy efficiency (EE) management in a communication network, wherein:
   the NNF is implemented by communication interface circuitry and processing circuitry that are operably coupled; and
   the processing circuitry and interface circuitry are configured to perform operations corresponding to any of the methods of embodiments D1-D6.
I2. A network node or function (NNF) configured for service-level energy efficiency (EE) management in a communication network, the NNF being further configured to perform operations corresponding to any of the methods of embodiments D1-D6.
I3. A non-transitory, computer-readable medium storing computer-executable instructions that, when executed by processing circuitry associated with a network node or function (NNF) configured for service-level energy efficiency (EE) management in a communication network, configure NNF to perform operations corresponding to any of the methods of embodiments D1-D6.
I4. A computer program product comprising computer-executable instructions that, when executed by processing circuitry associated with a network node or function (NNF) configured for service-level energy efficiency (EE) management in a communication network, configure NNF to perform operations corresponding to any of the methods of embodiments D1-D6.
J1. An application function (AF) configured to provide a service to end users via a communication network, wherein:
   the AF is implemented by communication interface circuitry and processing circuitry that are operably coupled; and
   the processing circuitry and interface circuitry are configured to perform operations corresponding to any of the methods of embodiments E1-E4.
J2. An application function (AF) configured to provide a service to end users via a communication network, the AF being further configured to perform operations corresponding to any of the methods of embodiments E1-E4.
J3. A non-transitory, computer-readable medium storing computer-E4ecutable instructions that, when E4ecuted by processing circuitry associated with an application function (AF) configured to provide a service to end users via a communication network, configure NNF to perform operations corresponding to any of the methods of embodiments E1-E4.
J4. A computer program product comprising computer-E4ecutable instructions that, when E4ecuted by processing circuitry associated with an application function (AF) configured to provide a service to end users via a communication network, configure NNF to perform operations corresponding to any of the methods of embodiments E1-E4.

1. A method for a service-level energy efficiency, EE, control function, SEECF, of a communication network, the method comprising:
receiving an EE management request related to a service provided to end users via the communication network;
obtaining, from a data analytics function, DAF, of the communication network, EE information related to the service's operation in the communication network;
determining an EE policy for the service based on the EE management request and on the obtained EE information; and
configuring one or more of the following in the communication network to operate according to the determined EE policy:
one or more network nodes or functions, NNFs, that carry or facilitate data traffic for the service; and
one or more management functions, MFs, that control or manage the NNFs.

2. The method of claim 1, wherein the EE management request includes one or more of the following:
an identifier of the service;
a requested EE level for delivery of the service by the communication network; and
a network performance metric associated with the requested EE level.

3. The method of claim 2, wherein the EE management request also includes one or more of the following:
a user plane path filter that identifies user plane paths through the communication network that are associated with the service; and
an Internet Protocol, IP, filter that identifies one or more IP flows associated with the service; and
one or more identifiers of user equipment, UE, to which the EE management request applies.

4. The method of claim 2, wherein the determined EE policy includes one or more policy entries, with each policy entry including the following:
an indication of a portion of the communication network to which the policy entry applies;
a required EE level for the indicated portion of the communication network; and
an identifier of the service.

5. The method of claim 4, wherein the indication of the portion of the communication network to which the policy entry applies includes one or more of the following:
one or more identifiers of user equipment, UE;
a user plane path filter, which includes a set of NNF identifiers corresponding to a user plane path through the communication network; and
an NNF filter, which identifies one or more specific NNFs.

6. The method of claim 4, wherein each policy entry also includes one or more of the following:
an Internet Protocol, IP, filter that identifies one or more IP flows associated with the service; and
a network performance metric associated with the required EE level.

7. The method of claim 2, wherein the network performance metric associated with the requested EE level or the required EE level is one of the following: data volume, throughput, or latency.

8. The method of claim 1, wherein obtaining the EE information from the DAF comprises:
sending to the DAF a request for the EE information, wherein the request for the EE information includes one or more of the following:
an identifier of the service;
an Internet Protocol, IP, filter that identifies one or more IP flows associated with the service;
a user plane path filter that identifies user plane paths through the communication network that are associated with the service; and
an NNF filter that identifies NNFs in the communication network that are associated with the service; and
receiving the EE information from the DAF in response to the request.

9. The method of claim 1, wherein the EE information obtained from the DAF includes one or more of the following related to the service's operation in the communication network:
one or more measured or predicted EE values; and
one or more recommended EE policies or actions.

10. The method of claim 9, wherein the EE information obtained from the DAF also includes one or more of the following from which the measured or predicted EE values or the recommended EE policies or actions were obtained: one or more network energy consumption values; and one or more network performance metrics.

11. The method of claim 9, wherein each of the measured or predicted EE values and each of the recommended EE policies or actions pertains to one of the following:
one or more instances of the service in the communication network,
one or more specific user plane paths in the communication network,
one or more specific NNFs in the communication network, or
all instances of the service and the entire communication network.

12. The method of claim 1, wherein determining an EE policy for the service based on the EE management request and on the obtained EE information comprises:
determining a set of user plane paths in the communication network that are associated with delivery of the service;
determining EE levels for the respective user plane paths based on the obtained EE information; and
determining a service-level EE in the communication network based on the EE levels for the respective user plane paths.

13. The method of claim 12, wherein determining an EE policy for the service based on the EE management request and on the obtained EE information further comprises, when the service-level EE does not meet or exceed a requested EE level included in the EE management request, adjusting EE policies for one or more of the user plane paths according to the EE capabilities of the respective NNFs, until an updated service-level EE determined based on the adjusted EE policies meets or exceeds the requested EE level.

14. The method of claim 1, wherein:
the EE management request is received from an application function, AF, configured to provide the service; and
the method further comprising sending to the AF an indication that EE management request can be fulfilled by the communication network.

15. A method for a data analytics function, DAF, configured to provide energy efficiency, EE, analytics in a communication network, the method comprising:
receiving, from a service-level EE control function, SEECF, of the communication network, a request for EE information related to operation of a service in the communication network;
determining the EE information requested by the SEECF; and
sending the determined EE information to the SEECF in response to the request,
wherein determining the EE information requested by the SEECF comprises one or more of the following:
obtaining measured EE information associated with the service from one or more of the following:
an energy analytics data repository, EADR, of the communication network;
one or more NNFs that carry or facilitate data traffic for the service; and
one or more management functions, MFs, that control or manage the NNFs; and
determining predicted EE information associated with the service based on past measured EE information, obtained from the EADR.

16-22. (canceled)

23. A method for an energy analytics data repository, EADR, of a communication network, the method comprising:
receiving, from a data analytics function, DAF, of the communication network, a query for EE information related to operation of a service in the communication network;
retrieving stored EE information in accordance with the query; and
sending the retrieved EE information to the DAF in response to the query,
wherein the retrieved EE information includes measured EE information associated with the service during one or more of the following: a current time period, and one or more past time periods.

24. (canceled)

25. The method of claim 23, wherein the measured EE information includes one or more of the following associated with the service in respective network nodes or functions, NNFs, that carry or facilitate data traffic for the service: network performance metrics, energy consumption metrics, and measured EE values.

26. The method of claim 25, wherein each network energy consumption metric associated with the service in an NNF is one of the following:
measured energy consumption for the service in the NNF during a current or past time period, or
a pro rata share of measured energy consumption for the NNF during the current or past time period, according to data volume of the service.

27. The method of claim 23, further comprising:
receiving the measured EE information from the respective NNFs that carry or facilitate data traffic for the service; and
storing the received measured EE information.

28. The method of claim 23, wherein one or more of the following applies:
the DAF is one of the following: a network data analytics function, NWDAF; or a management data analytics function, MDAF; and
the EADR is part of one of the following associated with the communication network: a unified data management, UDM, function; or a unified data repository, UDR.

29-58. (canceled)
